(19) United States
(12) Patent Application Publication
(10) Pub. No.: US 2012/0126137 A1
(43) Pub. Date: May 24, 2012

(54) ION IMPLANTATION METHOD AND ION IMPLANTER

(75) Inventor: CHENG-HUI SHEN, HSINCHU COUNTY (TW)

(73) Assignee: ADVANCED ION BEAM TECHNOLOGY, INC., HSINCHU (TW)

(21) Appl. No.: 12/950,366

(22) Filed: Nov. 19, 2010

(51) Int. Cl. H01J 3/14; G21K 5/10

(52) U.S. Cl. 250/397; 250/492.21

(57) ABSTRACT

An ion implantation method and an ion implanter with a beam profiler are proposed in this invention. The method comprises setting scan conditions, detecting the ion beam profile, calculating the dose profile according to the detected ion beam profile and scan conditions, determining the displacement for ion implantation and implanting ions on a wafer surface. The ion implanter used the beam profiler to detect the ion beam profile, calculate dose profile and determine the displacement and used the displacement in ion implantation for optimizing, wherein the beam profiler comprises a body with ion channel and detection unit behind the ion channel in the body for beam profile detection. The beam profiler may be a 1-dimensional, 2-dimensional or angle beam profiler.

### BACKGROUND OF THE INVENTION

1. Field of Invention

This invention relates to an ion implantation method, and in particularly, an ion beam profiler is used in the ion implantation method.

2. Background of the Related Art

As shown in FIG. 1, an ion implanter uses a filament 100 to ionize the atoms and/or atom clusters to form ions and/or ion clusters in source chamber 200. An electric field accelerates the ions/ion clusters to form an ion beam 610 and then the ion beam 610 is lead into the channel 300. After passing a mass spectrometer 400, the ions/ion clusters of the ion beam 610 are filtered to have a specific charge-mass ratio. Finally, the ion beam 610 injects into the implantation chamber 500 and bombards onto the surface of a wafer 520. A target base 510 are configured in the implantation chamber 500 for supporting the wafer 520, and a Faraday cup 600 is coupled with the implantation chamber 500 for detecting the beam current. The beam current can be read by an ion beam current detector 700, such as an ampere meter.

Referring to FIG. 2A, the ion beam continuously bombards on the wafer to form a implant line. The ion beam is controlled by the focused lens (magnetic field) or the wafer is moved by the target base to make the ion beam scan forward, shift with an distance, scan backward, shift with the distance, scan forward . . . on the wafer to form a plurality of parallel implant lines on the surface of the wafer. When the scan is done over the wafer surface, the wafer is rotated with an angle and the scan operation on the wafer surface is repeated. The rotation angle may be 90°, 60° or 45° . . . , that are respectively called quad, sexton, octal . . . mode scan. The shift distance is called a pitch and the pitch, denoted S, is equal to the distance between two adjacent implant lines, and one scan operation is called one implant that forms a group of parallel implant lines. The scan direction and the shifting direction are respectively defined as x-direction and y-direction. When the scan path, refer to FIG. 2B, does not pass the center of the wafer surface, the formed implant line does not pass the center also. The distance between the center and the scan line is called a displacement, denoted δ (.delta.). The displacement is equal to the distance between the center of the wafer surface and the implant line nearest to the center.

In regardless of the implant mode, it is most import that the group with 0° and the group with 180° of implant lines are parallel, and these two groups of implant lines notably affect the dose uniformity. A pitch shift Δ (.DELTA.) is introduced here, which is the shift distance of the wafer when the wafer is rotated and the next implant begins. The pitch shift Δ is used to avoid the dose to be non-uniform. Under specific scan conditions, the dose uniformity can be enhanced by controlling pitch shift Δ and displacement δ.

For better understanding, the quad implant mode is assumed in the following discussion. FIG. 3A sketches the implant lines with δ=S/2 and without pitch shift (Δ=0), and FIG. 4A sketches the implant lines with δ=S/2 and Δ=S/2. In the condition of δ=S/2, the dose uniformity with Δ=S/2 is better than that with Δ=0, respectively shown as FIG. 4B and FIG. 3B, because the implant lines with 0° and 180° rotation angles are overlapped in case of Δ=0. In condition of δ=S/4, FIG. 5A and FIG. 6A sketches the implant lines with Δ=0 and Δ=S/2. The dose uniformity with Δ=0 is better than that with Δ=S/2, respectively shown as FIG. 5B and FIG. 6B, because the implant lines with 0° and 180° rotation angles are overlapped in case of Δ=S/2.

The above analysis is based on an assumption that the ion beam profile is an ideal Gaussian distribution as shown in FIG. 7A, the centroid of an implant line is at the center of the ion beam with a fixed spreading in y-direction, the spreading is symmetrical to centroid and the implant line is a straight line. In figures, the distance between the centroid and ion beam is noted CT (centroid) and the spreading be SP (spreading). Unfortunately, the real ion beam profile is not an ideal Gaussian distribution as shown FIG. 7B. The centroid does not coincide with the ion beam center, the spreading is not symmetrical to the centroid and the implant lines are not straight and the above conditions lower the implant quality and dose uniformity.

The inventor of this invention proposes a new method to improve the dose uniformity, which is illustrated and explained as follows.

### SUMMARY OF THE INVENTION

According to an aspect of this invention, an ion implantation method is proposed. The method comprises detecting the ion beam profile, calculating the dose profile according to the detected ion beam profile, determining the displacement of the ion beam and implanting.

According to an aspect of this invention, the determined displacement can be used in the whole ion implantation, i.e. all rotation angles. According to an aspect of this invention, the determined displacement can be only used in one implant. i.e. the displacement is used in a rotation angle, and the displacement will be re-determined for next rotation.

According to an aspect of this invention, the beam profile comprises beam position, beam density and beam shape.

According to an aspect of this invention, a beam profiler is used to detect the ion beam profile, calculate the dose profile and determine the displacement. The ion beam profiler may be a 1-dimensional, 2-dimensional or angle beam profiler.

### BRIEF DESCRIPTION OF THE DRAWINGS

FIG. 1 shows an ion implanter.

FIGS. 2A and 2B sketches ion implant lines, the pitch and displacement.

FIGS. 3A, 4A, 5A and 6A sketches the implant lines.

FIGS. 3B, 4B, 5B and 6B sketches the dose uniformity, implant centroid and spreading of FIGS. 3A, 4A, 5A and 6A, respectively.

FIGS. 7A and 7B sketches the beam centroid and spreading of the ideal and real ion beams.

FIG. 8 shows the flow chart of implantation method of this invention.

FIG. 9 sketches a beam profiler of this invention.

FIGS. 10A, 10B and 10C respectively show the ion beam profile in 3-dimensional system (x-y-dose profile), and deviation and the spreading of the ion beam in x- and y-direction in 2-dimensional system (x-dose, y-dose).

FIG. 11 shows an ion implanter with an ion beam profiler.

### DETAILED DESCRIPTION OF THE INVENTION

In bi-, quad-, sexton-, octa- . . . mode ion implantation (implant mode), the displacement δ of an ion beam and pitch shift Δ are used to improve dose uniformity. In general, Δ=0; and δ=S/2 or S/4, where S is a pitch, the distance between two adjacent implant lines. Of course, the pitch shift Δ can be another value and the value may not be the limitation of the invention. In regardless of the implant mode, ion implantation is based on an ideal assumption that the ion beam profile is a perfect Gaussian distribution and the implant centroid is precisely positioned at the center of the ion beam.

Unfortunately, the ion beam is not a perfect Gaussian and the implant centroid is not precisely at the center of ion beam. The beam information includes beam position, beam intensity and beam shape, and is defined as a beam profile. Further, the real ion beam shape can not be completely controlled, the ion beam center may be biased and the ion beam intensity is not symmetrical to the ion beam center, and those uncontrollable factors distort the ideal assumption and lower the dose uniformity. The inventor, in this invention, proposes a new skill to optimize the dose uniformity by dynamically adjusting the displacement δ (.delta.) according to the beam profile.

Dose is predetermined, which is measured by ion (atom) numbers per unit area (ions/cm²), and the scan conditions are also predetermined. The scan velocity, the moving velocity of ion beam on the scan path, can be controlled to reach the predetermined dose. One scan is defined to be a forward or backward scan, and a forward scan and a backward scan form two parallel implant lines, and one implant includes a plurality of times scan to be over the wafer surface to form a group of parallel, and one whole implantation is defined to finish a wafer implantation. After one implant is finished, the ion beam or the wafer is shift and then the next implant is preceded, and the superposition of these implant lines forms a dose profile. The shift of the ion beam or the wafer can be determined by the displacement δ. As a result, the beam profile is corresponding to a dose profile, that is to say the dose profile can be calculated according to the ion beam profile, and the dose uniformity is determined by the dose profile. The inventor proposes that the displacement δ can be determined according to the beam profile to enhance quality of the dose profile, the dose uniformity.

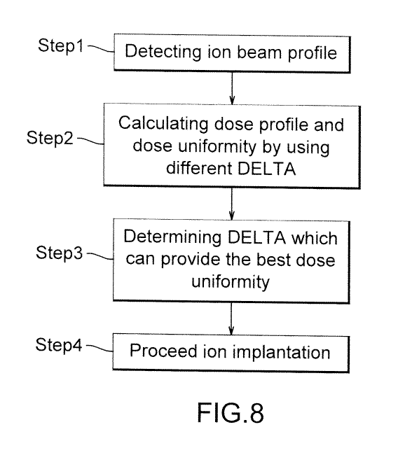

According to an aspect of this invention, an ion implantation method is proposed shown as FIG. 8, and the method comprises:
Step 1: detecting the ion beam profile,
Step 2: calculating the dose profile and dose uniformity according to the detected ion beam profile,
Step 3: determining the displacement δ of the ion beam according to the calculation, and
Step 4: implanting ions on wafer surface.

In step 1, an ion beam profile is detected before implanting. The ion beam may scan a beam profiler first, and the beam profiler detects and measures the ion beam. The ion beam profiler can be 1-dimensional (y-directional) or 2-dimensional (x- and y-directional) beam profiler for detecting the ion distribution in y-directional distribution or x-y-planar distribution. When ions bombard on the detector of the ion beam profiler to be detected, the ion distribution on the detector is similar with or same as ion distribution on the wafer surface.

In step 2, under the predetermined scan conditions, the detected beam profile is used to calculate the dose profile and dose uniformity by using a displacement δ, and different displacement δ is corresponding to different dose profile and dose uniformity. The calculated dose profile and dose uniformity is similar with or same as the dose profile and the dose uniformity on wafer surface.

In step 3, the optimized displacement δ_{M} can be determined, which is corresponding to the best dose uniformity. Different displacement δ is corresponding to different dose profile and dose uniformity, and the optimized displacement δ_{M} is corresponding to the best dose uniformity.

In step 4, the ion implantation is proceeded by using the optimized displacement δ_{M}. The optimized displacement δ_{M} is corresponding to the best calculated dose uniformity, and the best calculated dose uniformity is similar with or same as the dose uniformity on wafer surface. As a result, the dose uniformity on the wafer surface is the best.

It is noted that the optimized displacement δ_{M} can be used in one implant or a whole ion implantation. In one embodiment, the optimized displacement δ_{M} is used in whole ion implantation. In the example, the optimized displacement δ_{M} is used till the scan operation is complete, that includes implantation in all rotation angles in quad, sexton, octal . . . mode implant. In another embodiment, the optimized displacement δ_{M} is used in one implant, that only includes one implant, and in next implant, the optimized displacement δ_{M} is recalculated.

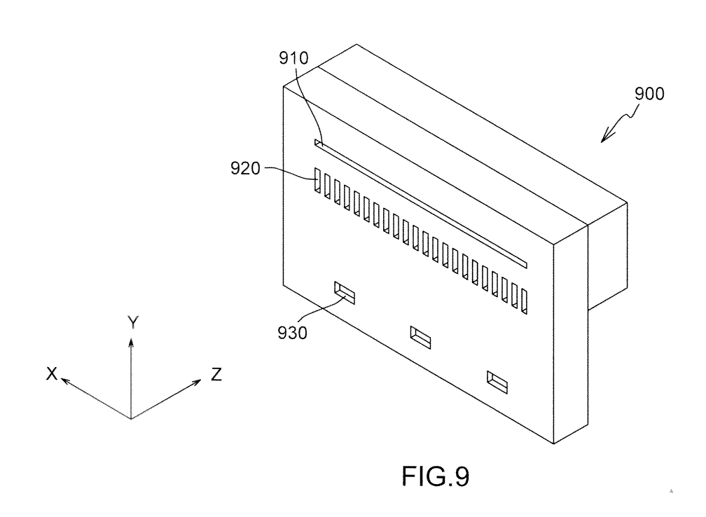

Continuously, the inventor provides the embodiments of a 1-dimensional, 2-dimensional and angle ion beam profiler. It is noted that the embodiments is used to illustrate this invention not to limit the scope of the invention. Refer to FIG. 9, the profiler 900 integrates three kinds of ion beam profiler for convenience to explain the ion beam profilers, but however these ion beam profilers can be separated and used alone or like this drawing multiple beam profilers are integrated together. The ion beam profiler comprises a body with at least one channel arranged in a special pattern and at least one detection unit (not shown) behind the channel. For example, the channel is configured as a slot or a set of arranged holes.

For example, 1-dimensional beam profiler 910 comprises a channel, which is configured as a slot, and the detection unit behind the slot, shown at the upper of FIG. 9. The ion beam scans the 1-dimensional beam profiler 910, which is configured to be bar slot along x-direction, from top to bottom (y-direction), and the ion beam profile is detected by the detection unit when the ions pass the slot, and a y-directional beam profile is obtained. The y-directional beam profile is detected and then the corresponding y-directional dose profile can be calculated and the dose uniformity can be found

For example, 2-dimensional beam profiler 920 comprises a channel, which is configured as an array or a matrix of holes, and detection unit behind these holes, shown at the middle of the FIG. 9. The ion beam passes the holes and sensed by the detection unit to form a 2-dimensional contour map of the ion beam. The 2-dimensional contour map is corresponding to x-y-planar beam profile, and the dose profile can be calculated by the beam profile, and finally, the dose uniformity can be determined.

For example, the angle beam profiler comprises a channel, which is configured as a row of three holes 930, and a detection unit behind the holes, shown at the lower of FIG. 9. The ion beam passes these holes to the detection unit and the beam angle profile can be detected. The beam centroid and the spreading can be obtained by the beam angle profile, so the dose profile can be calculated by the centroid and the spreading of the beam angle profile, and the best displacement is found also.

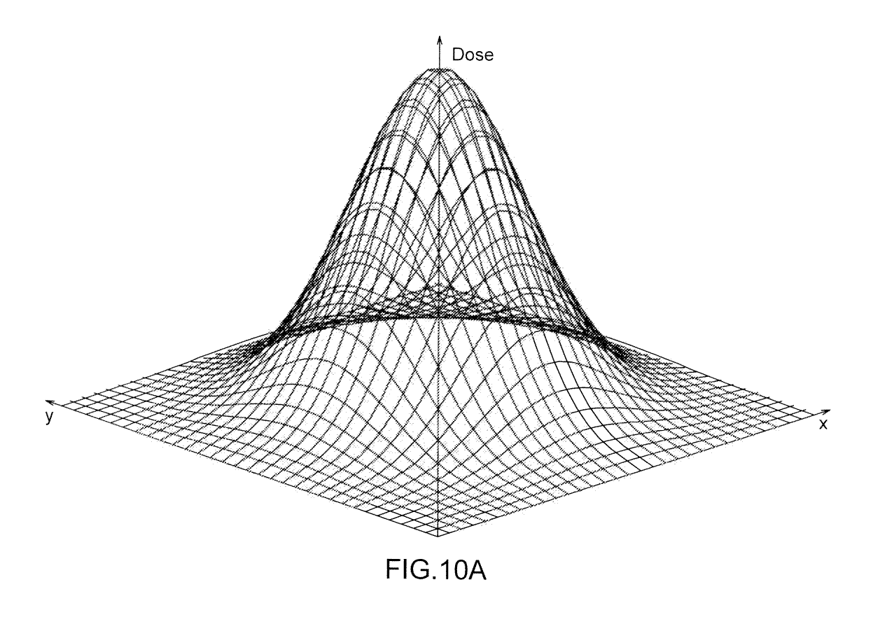

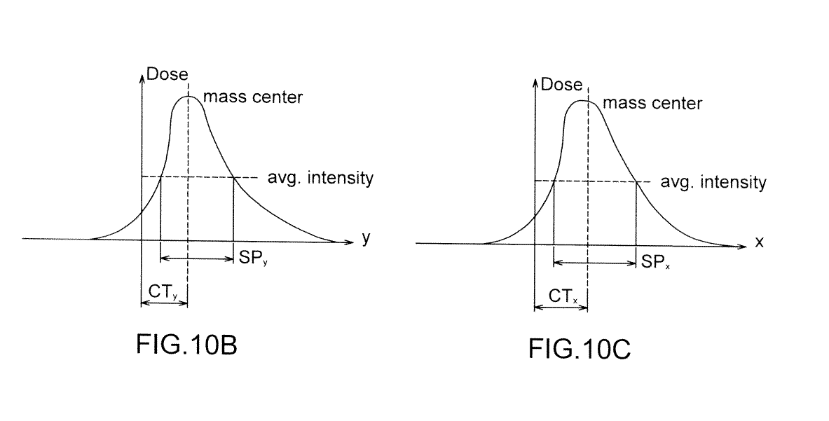

The 1-dimensional and the 2-dimensional can be integrated to figure out beam shape, and the beam shape can be shown as a 3-dimensional beam profile, x-y-dose profile shown as FIG. 10A. FIG. 10B and FIG. 10C respectively show the deviation of the beam centroid and the spreading width in x- and y-direction. Once the beam profile is obtained, the beam profile can be calculated to easily determine the optimized displacement δ_{M}.

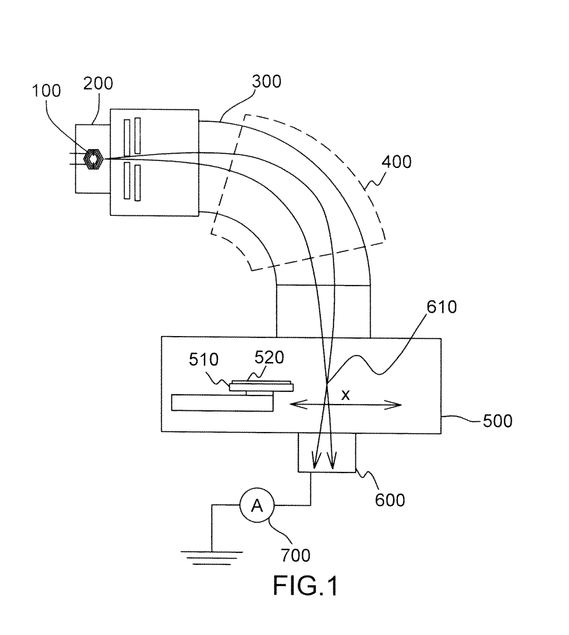

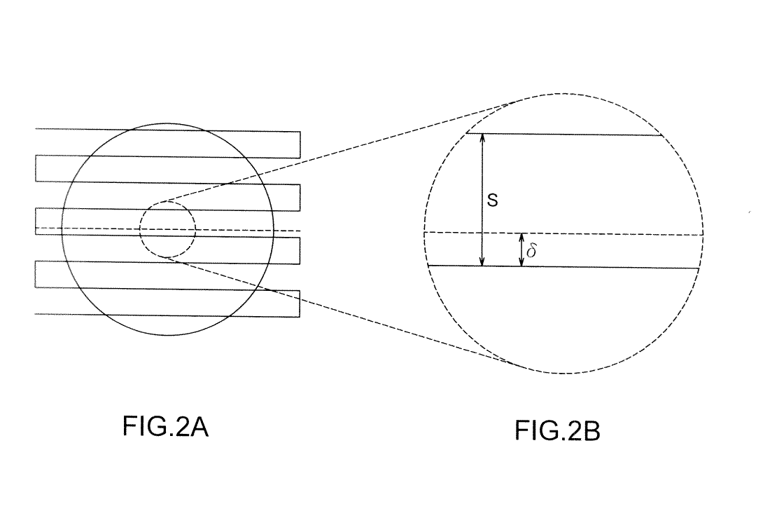

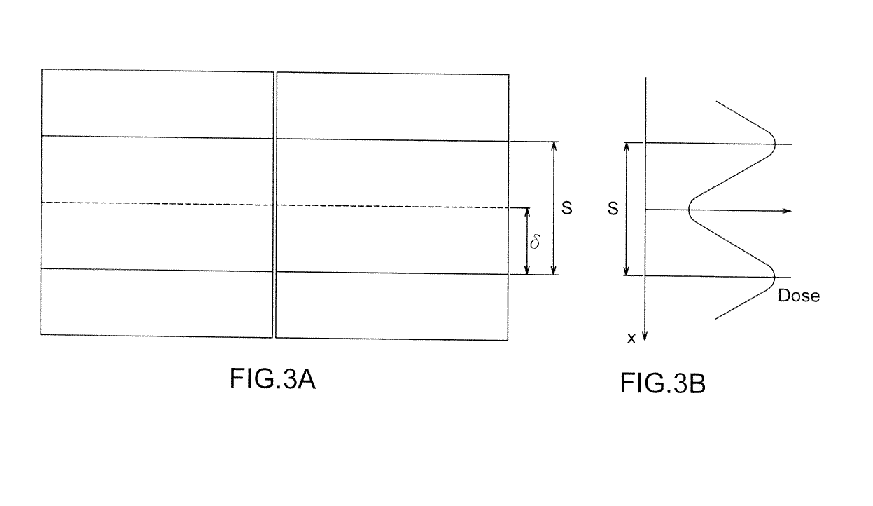

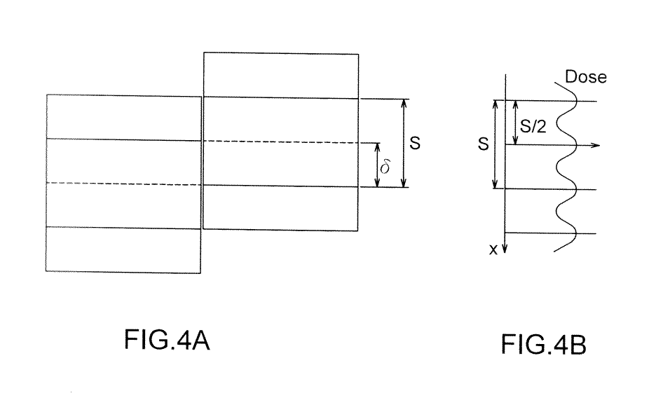

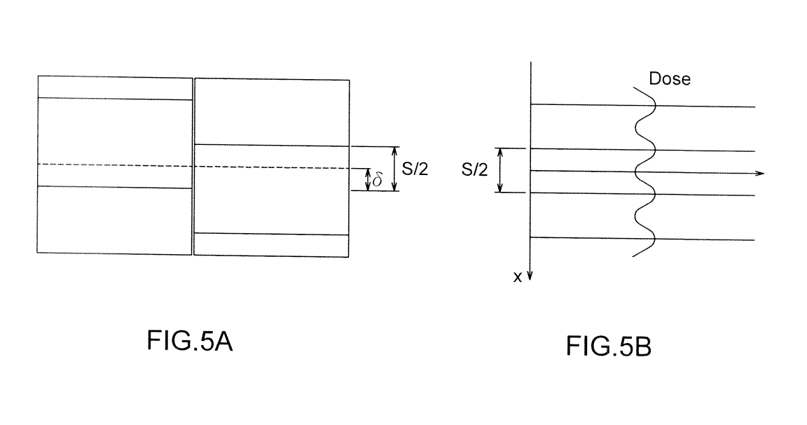

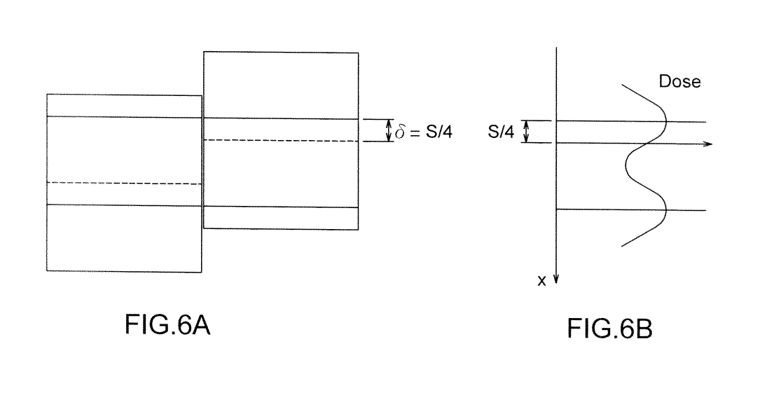

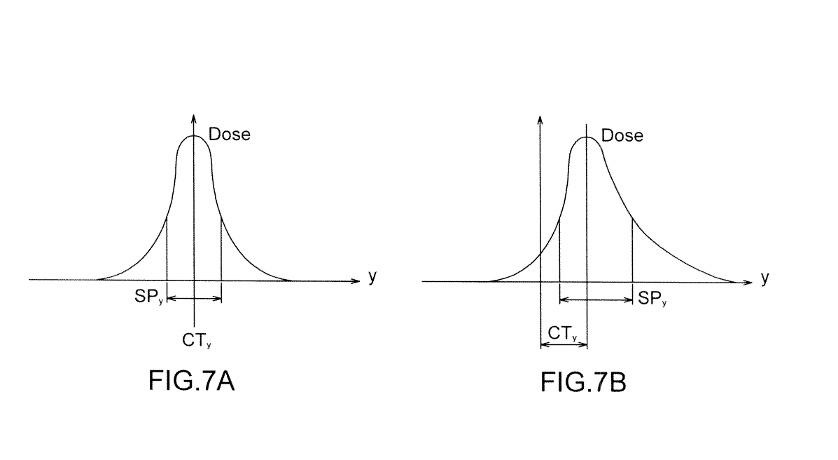

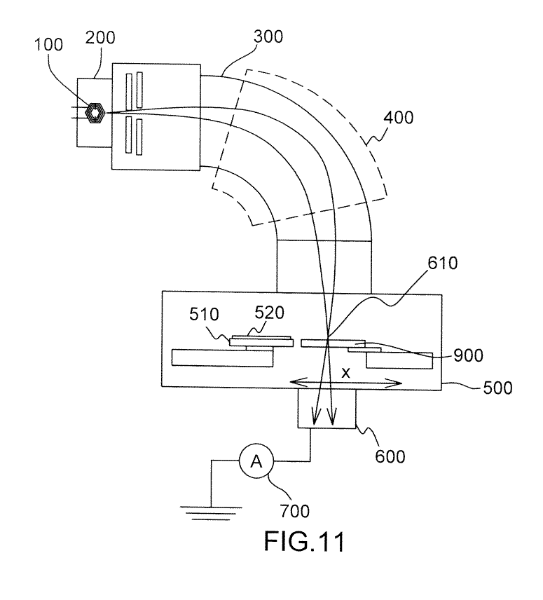

FIG. 11 shows an embodiment of an implanter, which comprises an ion beam profiler 900. The ion beam profiler can detect the beam profile and calculate the dose profile and dose uniformity. Therefore, the ion beam profiler can be positioned at the position of the wafer to get the most real dose profile, and of course, the beam profiler can be put another position. The other elements of the ion implanter and the configuration are similar with that shown in FIG. 1.

Although this invention has been explained in relation to its preferred embodiment, it is to be understood that modifications and variation can be made without departing the spirit and scope of the invention as claimed.

What is claimed is:

1. An ion implantation method comprising:
detecting an ion beam profile:
calculating an dose profile and dose uniformity according to the ion beam profile;
determining an optimized displacement of the ion beam according to the calculation; and
implanting ions on a wafer surface with the optimized displacement for a whole scan operation.

2. An ion implantation method according to claim 1, wherein a beam profiler is used in detecting step.

3. An ion implantation method according to claim 2, wherein the beam profiler is a 1-dimensional beam profiler for detecting one dimensional beam profile.

4. An ion implantation method according to claim 3, wherein the 1-dimensional beam profiler comprises a body with a slot and a detection unit behind the slot in the body.

5. An ion implantation method according to claim 2, wherein the beam profiler is a 2-dimensional beam profiler for detecting two dimensional beam profile.

6. An ion implantation method according to claim 5, wherein the 2-dimensional beam profiler comprises a body with an array of holes and a detection unit behind the holes in the body.

7. An ion implantation method according to claim 5, wherein the 2-dimensional beam profiler comprises a body with a matrix of holes and a detection unit behind the holes in the body.

8. An ion implantation method according to claim 2, wherein the beam profiler is an angle beam profiler for detecting beam angle profile, which comprises beam centroid and spreading.

9. An ion implantation method according to claim 8, wherein the angle beam profiler comprises a body with a row of three holes and a detection unit behind the holes in the body.

10. An ion implantation method according to claim 1 being applied to a bi-mode, quad-mode, sexton-mode and octo-mode implant.

11. An ion implantation method comprising:
detecting an ion beam profile;
calculating an dose profile and dose uniformity according to the ion beam profile;
determining an optimized displacement of the ion beam according to the calculation;
implanting ions on a wafer surface with the optimized displacement for a scan path; and
repeating the above steps to finish a whole scan operation.

12. An ion implantation method according to claim 11, wherein a beam profiler is used in detecting step.

13. An ion implantation method according to claim 12, wherein the beam profiler is a 1-dimensional beam profiler for detecting one dimensional beam profile.

14. An ion implantation method according to claim 13, wherein the I-dimensional beam profiler comprises a body with a slot and a detection unit behind the slot in the body.

15. An ion implantation method according to claim 12, wherein the beam profiler is a 2-dimensional beam profiler for detecting two dimensional beam profile.

16. An ion implantation method according to claim 15, wherein the 2-dimensional beam profiler comprises a body with an array of holes and a detection unit behind the holes in the body.

17. An ion implantation method according to claim 15, wherein the 2-dimensional beam profiler comprises a body with an matrix of holes and a detection unit behind the holes in the body.

18. An ion implantation method according to claim 12, wherein the beam profiler is an angle beam profiler for detecting beam angle profile, which comprises beam centroid and spreading.

19. An ion implantation method according to claim 18, wherein the angle beam profiler comprises a body with a row of three holes and a detection unit behind the holes in the body.

20. An ion implantation method according to claim 11 being applied to a bi-mode, quad-mode, sexton-mode and octo-mode implant.

21. An ion implanter comprising:
an ion beam profiler, wherein the ion beam profiler detects an ion beam profile, calculates a dose profile and dose uniformity, determines an optimized displacement and the beam profiler comprises:
a body with at lease a channel; and
a detection unit behind the slot or the holes with in the body.

22. An ion implanter according claim 21, wherein the channel is configured as a slot for detecting 1-dimensional beam profile.

23. An ion implanter according claim 21 wherein the channel is configured as an array or a matrix of holes for detecting 2-dimensional profile.

24. An ion implanter according claim 21, wherein the channel is configured as a row of three holes for detecting angle beam profile.

25. An ion beam profiler, applied to an ion implanter, comprising:
a body with at least a channel; and
a detection unit behind the channel in the body.

26. An ion profiler according to the claim 25 wherein the channel is configured as a slot for detecting a 1-dimensional beam profile.

27. An ion profiler according to the claim 25, wherein the channel is configured as an array or a matrix of holes for detecting a 2-dimensional beam profile.

28. An ion profiler according to the claim 25, wherein the channel is configured as a row of three holes for detecting an angle beam profile, which comprises beam centroid and spreading.
